(19) United States
(12) Patent Application Publication
(10) Pub. No.: US 2018/0013842 A1
(43) Pub. Date: Jan. 11, 2018

(54) METHOD AND SYSTEM FOR PROVIDING USER WITH INFORMATION RELATED TO PREMISES

(71) Applicant: Leanor Oy, Salo (FI)

(72) Inventors: Miikka Lehtinen, Turku (FI); Mika Kännö, Piikkio (FI); Jukka Kontulainen, Salo (FI); Annika Laaksonen, Salo (FI)

(21) Appl. No.: 15/201,825

(22) Filed: Jul. 5, 2016

(51) Int. Cl. H04L 29/08; G06Q 50/16; G06T 11/60; H04W 4/04; G06Q 10/10

(52) U.S. Cl. CPC H04L 67/18; H04W 4/043; H04L 67/02; G06Q 10/1093; G06T 11/60; G06Q 50/16; G06T 2200/24

(57) ABSTRACT

Disclosed is a method of providing information related to a first premises (102) to a first user (106). The method may include associating an information with the first premises (102). Further, the method may include associating an identification of one or more radio transmitters with the first premises (102). Furthermore, the method may include receiving the identification of the associated one or more radio transmitters. Additionally, the method may include using the received identification to select the associated information to be provided to the first user (106).

### TECHNICAL FIELD

The present disclosure relates generally to providing users with information related to premises; and more specifically, to methods and systems of identifying information associated with a premises to be provided to users based on one or more radio transmitters placed in the premises.

### BACKGROUND

Individuals interested in purchasing and/or renting real estate properties usually wish to obtain relevant information regarding a premises before making a decision. Such information may include details regarding the premises such as area, number of rooms, room layout, description of furnishing and so on. Further, individuals generally wish to survey a significant number of premises and select one of them according to their needs. Furthermore, the individuals may wish to see how the interior of a premises may appear with a furnishing, while the premises may actually lack any furnishing or may have a different kind of furnishing.

Accordingly, existing systems provide individuals with information related to a premises through an online platform. For instance, a real estate property platform may enable users to search for premises based on a set of criteria and accordingly provide a listing of one or more premises along with relevant information. However, such information is provided to the user in response to an explicit action, such as searching, performed by the user. In some cases, this may be burdensome to users.

Further, in case a user is interested in evaluating a significant number of potential premises, existing systems provide the relevant information regarding each of the potential premises to the user in a collective manner. For instance, a webpage provided to the user may include a list of hyperlinks corresponding to multiple potential premises. Accordingly, the user may click on a hyperlink corresponding to a premises of current interest and view relevant information.

As a result, users are currently presented with a large quantity of information at a time, while only a part of it may be relevant in a given context. In other words, although users sequentially visit each of potential premises, they are provided with the relevant information pertaining to all the potential premises together, at once. Accordingly, users are required to wade through this information to identify and view relevant information associated with a premises currently under evaluation.

Alternatively, while a user is visiting a premises for evaluation, the user may search the online platform to obtain and view the relevant information. For instance, upon reaching a premises, the user may input an address of the premises into a search engine provided by the online platform. Accordingly, the user may be presented with the relevant information. However, the step of searching to be performed by the user causes additional burden on the user.

Further, relevant information regarding a premises may also include images of the interior of the premises. Accordingly, existing systems provide users with computer generated views depicting an interior of a premises according to various furnishings such as wall-papers, carpets, furniture and so on. These views are provided to the user in the form of a virtual tour. Accordingly, a user may perform a virtual walk-through within a three-dimensional representation of the premises while being presented views of the interior according to the user's position in the walk-through. In other words, users are required to provide navigation instructions such as walk, turn, zoom etc. in order to explore the interior of the premises from different positions and viewing angles. However, such an interface is not intuitive to most users.

Furthermore, some existing systems provide users with augmented views of an interior. Accordingly, a user may capture an image of the interior using a device, such as a smartphone camera and select a furnishing to be applied onto the image. As a result, objects such as wall, flooring, furniture etc. may be recognized in the image and the selected furnishing may be digitally applied to generate an augmented image. However, such techniques require a presence of an object with known physical dimensions, such as a magazine, to be present in the image. This leads to inconvenience to users as they may be required to place such a known object within the view of the camera. Moreover, while capturing images of large rooms, an image size of the known object may be too small to allow reliable detection of its physical dimensions.

Therefore, in light of the foregoing discussion, there exists a need to overcome the aforementioned drawbacks.

### SUMMARY

The present disclosure seeks to provide a method of providing users with information related to a premises. Additionally, the present disclosure seeks to provide a system configured to provide users with information related to a premises. A further object of the present disclosure is to provide a system and method that overcome at least partially the drawbacks in the prior art. For example, the present disclosure seeks to provide a system and method that enable easy use of information related to a premises as well as a possibility to test furnishing in an easy and reliable manner.

Accordingly, in one aspect, an embodiment of the present disclosure is a method for providing information related to a first premises to a first user. The method comprises associating an information with the first premises and associating an identification of at least one radio transmitter with the first premises. The method also comprises receiving the identification of the associated at least one radio transmitter and using the received identification to select the associated information to be provided to the first user.

In another aspect, an embodiment of the present disclosure provides a system for providing information related to a first premises to a first user. The system comprises a communication module configured to receive identification of at least one radio transmitter. Further, the system comprises a processing module configured to associate an information with the first premises, associate an identification of at least one radio transmitter with the first premises and select the associated information to be provided to the first user based on the identification received by the communication module.

Embodiments of the present disclosure substantially eliminate or at least partially address the aforementioned problems in the prior art, and enable providing users with relevant information related to a premises without requiring users to perform an explicit action, such as searching. Accordingly, a user may receive relevant information of a premises by merely being physically present within and/or in the vicinity of the premises. Further, the relevant information provided to the user is based on a current context, such as the premises currently under visit by a user. Accordingly, users are not overwhelmed with information that may not be of immediate interest in a given context. Further, a user may be provided with an augmented view of the interior of the premises based on a location of the user within the premises. Accordingly, the location may be accurately determined based on signals transmitted from the one or more radio transmitters to a mobile device carried by the user. As a result, the user may naturally move around the premises without requiring to provide explicit navigation commands, while being presented with corresponding augmented views according to the varying position. Further, the augmented view may be generated without requiring placement of an object with known physical dimensions within the premises.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a plurality of radio transmitters placed in a premises to facilitate detection of a user's location within the premises;

FIG. 2 is a schematic illustration of a system for controlling one or more radio transmitters placed in a premises;

FIG. 3 is a schematic illustration of flow of signals from one or more radio transmitters to a server through one or more mobile devices;

FIG. 4 is a schematic illustration of a technique of associating one or more radio transmitters with a premises based on signals transmitted from the one or more radio transmitters to a server through a mobile device;

FIG. 5 is a schematic illustration of a user interface, including information regarding a premises, presented to a user located in the premises;

FIG. 6 is a schematic illustration of an augmented view of an interior of a premises presented on a mobile device located within the premises;

FIG. 7 is a schematic illustration of another augmented view of an interior of a premises presented on a mobile device located within the premises;

FIG. 8 is an illustration of a flow chart of a method of providing information related to a premises to users; and

FIG. 9 is a schematic illustration of a system for providing information related to a premises to users.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure is a method for providing information related to a first premises to a first user. The method comprises associating an information with the first premises and associating an identification of at least one radio transmitter with the first premises. The method also comprises receiving the identification of the associated at least one radio transmitter and using the received identification to select the associated information to be provided to the first user.

According to an embodiment, associating the identification of the at least one radio transmitter with the first premises comprises steps of: identifying the first premises based on a first data associated with a second user; receiving a first set of identifications of a first set of radio transmitters; receiving a second set of identifications of a second set of radio transmitters; comparing the first set of identifications with the second set of identifications for finding at least one radio transmitter identification in the first set of identifications, which at least one radio transmitter identification is absent from the second set of identifications; and associating the at least one radio transmitter with the first premises, wherein said at least one radio transmitter is associated with the found at least one radio transmitter identification.

Further, in an embodiment, the method may further comprise using a plurality of radio transmitters in the first premises to locate the first user within the premises.

Further, in an embodiment, the information associated with the first premises may be a website. Further, in an embodiment, the information associated with the first premises may be a data for augmenting a view. Further, in an embodiment, the first data may be a calendar note. Further, in an embodiment, the first data may be a position information of the second user.

In an embodiment, the method relates to providing information related to the premises on a mobile device based on proximity of the mobile device to one or more radio transmitters. The method may include a step of receiving identification of the one or more radio transmitters from a first mobile device. Accordingly, the first mobile device may be configured to receive the identification of the one or more radio transmitters transmitted by the one or more radio transmitters placed within a premises. Further the mobile device may be configured to send the received identification of the one or more radio transmitters to a server remotely located from the premises. The server may receive the identification from the mobile device and process it with a processing module. Based on a results of the processing the server can provide information to the person visiting the premises. Thus the method and system may function in a way that one or more radio transmitters are located within a premises, and thereafter one mobile device is used communicate identification of the radio transmitters said radio transmitter(s) which are associated with said premises. When a further user (for example a person looking for an apartment to rent) visits the premises, he/she will then receive information relevant to that premises on his/her mobile device.

Additionally, the method may include a step of receiving a first data from the first mobile device. Further, the method may include a step of associating information related to the premises with the identification of the one or more radio transmitters based on the first data. Further, the information related to the premises may correspond to the premises. Furthermore, the method may include a step of receiving a query from a second mobile device. The query may include the identification of the one or more radio transmitters. Accordingly, the second mobile device may be configured to transmit the query based on receipt of the identification of the one or more radio transmitters transmitted by the one or more radio transmitters. Additionally, the method may include a step of identifying the information related to the premises associated with the identification of the one or more radio transmitters in the query. Further, the method may include a step of transmitting the information related to the premises to the second mobile device based on the identifying. Accordingly, the second mobile device may be configured to present the information related to the premises.

In another aspect, an embodiment of the present disclosure is a system for providing information related to a first premises to a first user. The system comprises a communication module configured to receive identification of at least one radio transmitter. Further, the system comprises a processing module configured to associate an information with the first premises, associate an identification of at least one radio transmitter with the first premises and select the associated information to be provided to the first user based on the identification received by the communication module.

In an embodiment, in order to associate the identification of the at least one radio transmitter with the first premises, the communication module is configured to receive a first set of identifications of a first set of radio transmitters; and receive a second set of identifications of a second set of radio transmitters. Further, the processing module is configured to identify the first premises based on a first data associated with a second user; compare the first set of identifications with the second set of identifications for finding at least one radio transmitter identification in the first set of identifications, wherein the at least one radio transmitter identification is absent from the second set of identifications; and associate the at least one radio transmitter with the first premises, wherein the at least one radio transmitter is associated with the found at least one radio transmitter identification.

In an embodiment, the system may further comprise a plurality of radio transmitters in the first premises to locate the first user within the premises. Further, in an embodiment, the information associated with the first premises may be a website. Further, in an embodiment, the information associated with the first premises may be a data for augmenting a view. Further, in an embodiment, the first data may be a calendar note. Further, in an embodiment, the first data may be a position information of the second user.

In another embodiment, the system relates to providing information related to a premises on a mobile device based on proximity of the mobile device to one or more radio transmitters. The system may include a communication module configured to receive identification of the one or more radio transmitters from a first mobile device. Accordingly, the first mobile device may be configured to receive the identification transmitted by the one or more radio transmitters placed within a premises. Additionally, the communication module may be configured to receive a first data from the first mobile device. Further, the communication module may be configured to receive a query from a second mobile device. The query may include the identification of the one or more radio transmitters. Accordingly, the second mobile device may be configured to transmit the query based on receipt of the identification transmitted by the one or more radio transmitters. Additionally, the communication module may be configured to transmit information related to the premises to the second mobile device in response to the query. Accordingly, the second mobile device may be configured to present the information related to the premises. Further, the system may include a processing module configured to associate the real estate data with the identification of the one or more radio transmitters based on the first data. Additionally, the processing module may be configured to identify the information related to the premises associated with the identification included in the query. Furthermore, the system may include a storage module configured to store each of the information related to the premises and an association between the information related to the premises and the identification.

In an embodiment, the present disclosure includes a system for providing information related to a first premises to a first user. In general, the system may be an information processing device capable of performing operations such as receiving, transmitting, processing and storing data. Accordingly, the system includes modules such as a communication module and a processing module and may further include other modules such as a storage module.

In an instance, the information related to a premises, such as the first premises, may be required to be presented on a mobile device of a user, such as the first user. For example, the system may be configured to present information related to a premises on a mobile device carried by a user present within and/or in the vicinity of the premises. Examples of the mobile device may include, but are not limited to, a mobile phone, a smartphone, a tablet computer, a laptop computer and a wearable computer.

Accordingly, in one instance, the system may be configured to communicate with other electronic devices, such as the mobile device, over one or more communication channels, such as, but not limited to, Near Field Communication (NFC), Bluetooth Communication, Infrared Data Association (IrDA) channel, Wi-Fi, local area network (LAN), a virtual private network (VPN), the Internet, a cellular telephone network, and a public switched telephone network. For example, the system may be a server computer configured to communicate with the mobile device of the user over a communication network, such as the Internet. In other words, in an instance, the system may be external to the mobile device of the user on which the information related to the premises is to be presented.

However, in an embodiment, the system may be instantiated in the form of the mobile device of the user. Therefore, one or more operations needed to present the information related to the premises may be performed by the mobile device. Accordingly, the system may include one or more presentation devices such as, but not limited to, a display device and a loud speaker that may be configured to present the information related to the premises. Additionally, the system may include one or more input devices such as, but not limited to, a touch-screen, that may be configured to receive an input from the user.

The information related to the premises in general may include any information regarding the premises that may be of interest to one or more users, including the user, such as, for example, potential buyers or renters of the premises, sales agents, construction workers, law enforcement officials, emergency rescue personnel, renovation personnel, architects and interior designers.

For instance, the information related to the premises may include a listing description of the premises that may inform users about various aspects of the premises such as a description of the premises, number and type of rooms, floor plan, built-up area, carpet area, offered price, available utilities such as water, electricity, gas, heating, cooling, Wi-Fi etc., nearby landmarks, distances to nearby landmarks, year of construction of the premises, restrictions such as disallowance of pets and so on. Accordingly, in some instances, the information related to the premises may be included in a website and/or a hyperlink of the website.

Additionally, the information related to the premises may include images of one or more of an exterior of the premises and an interior of the premises. The images may be still images and/or moving images, such as a video. Further, the images of the interior of the premises may include images captured from multiple viewpoints and/or multiple locations within the premises. Accordingly, users may be able to visually experience the premises from different vantage points.

Furthermore, the information related to the premises may also include images of one or more furnishing objects, such as wall paint, wall-papers, carpets, curtains and furniture. Additionally, the information related to the premises may also include augmented images of one or more of an exterior of the premises and an interior of the premises.

An augmented image may be generated digitally by superimposing an image of a furnishing object over an image of an interior view and/or an exterior view of the premises. For example, an image of the premises with no furnishing may be obtained and digitally altered by superimposing an image of a sofa and a table onto the image of the premises. Accordingly, the augmented image may provide a visual experience to the user as if the corresponding real objects were placed within the premises.

Further, the information related to the premises may be presented through a user interface displayed on the mobile device of the user. For example, the user interface may include a listing description. Additionally, the user interface may include a GUI element configured to receive a user input and display the floor plan of the premises. Further, the user interface may include a GUI element configured to receive a user input and subsequently enable the user to place an offer for the premises. Furthermore, the user interface may include a GUI element configured to receive a user input and subsequently provide an augmented view of the premises to the user.

In order to present the information related to the premises to the user, the system may be configured to determine that the user is located within and/or in the vicinity of the premises. Accordingly, the system may be configured to communicate with the mobile device carried by the user, such as, for example, a smartphone. Further, the mobile device may be configured to receive an electromagnetic signal transmitted by one or more radio transmitters, located within and/or in the vicinity of the premises. The electromagnetic signal may be transmitted by the one or more radio transmitters over a communication channel, such as, but not limited to, Bluetooth. Accordingly, the mobile device may communicate receipt of the electromagnetic signal to the system, indicating the physical presence of the user within and/or in the vicinity of the premises.

Accordingly, a radio transmitter of the one or more radio transmitters may be configured to transmit electromagnetic signals. Moreover, the electromagnetic signals may include identification of the radio transmitter. For instance, the radio transmitter may include a memory module, such as a Read Only Memory (ROM) configured to store the identification, such as a serial number. Further, the identification may be unique to the radio transmitter. Additionally, the radio transmitter may include RF transmission circuitry configured to access the identification from the memory module and transmit the identification in the form of electromagnetic waves over a predefined channel. For example, the radio transmitter may be configured to transmit the identification over short range communication such as, for example, a Bluetooth channel. Accordingly, any electronic device capable of establishing communication over Bluetooth protocol may receive the identification from the radio transmitter.

Moreover, the radio transmitter may be configured to transmit the electromagnetic signal periodically at a predetermined time interval, such as for example, 5 seconds. Further, the radio transmitter may include an energy source such as a battery in order to power the electronic circuitry of the radio transmitter.

Additionally, in an embodiment, the radio transmitter may also be configured to receive electromagnetic signals from another electronic device, such as for example, a mobile device at the premises. In other words, the communication channel represents a communication link between the radio transmitter and the system mediated by the mobile device at the premises. The mobile device at the premises may be carried by a user such as, for example, a sales agent and/or a client.

Further, the electromagnetic signals may be received over short range communication, such as Bluetooth. Accordingly, in some instances, the mobile app included in a mobile device at the premises may be configured to transmit the control commands to the radio transmitter over the short range communication. Further, the system may be configured to transmit the control commands to the mobile device at the premises. Accordingly, the communication channel may include a long range communication link between the system and the mobile device at the premises and a short range communication link between the mobile device at the premises and the radio transmitter.

As an example, the control commands may include a wake-up command configured to cause the radio transmitter to transition from a low power state to a high power state. Alternatively, the control command may include a sleep command configured to cause the radio transmitter to transition from a high power state to a low power state. Additionally, in an embodiment, the control commands may include a time indicator corresponding to issuance of one or more of a wake-up command and a sleep command. Accordingly, the radio transmitter may be configured to remain in one of the high power state and the low power state according to the time indicator.

For instance, the mobile app executable in the mobile device at the premises may be configured to transmit the wake-up command to the radio transmitter. The wake-up command may be transmitted in response to a user input to the mobile app. Alternatively, the wake-up command may be transmitted in response to a control signal received from the system. Accordingly, for instance, the user, such as a sales agent who may have placed the radio transmitter in the premises, may remotely control an operational state of the radio transmitter.

For example, the mobile device of the sales agent may include a mobile app configured to transmit control commands associated with the radio transmitter to the system over a communication channel, such as, but not limited to, the Internet. Accordingly, the sales agent may provide an input the mobile app to indicate a need to wake-up the radio transmitter. The sales agent may be located remotely from the premises. Further, the sales agent may also provide a selection input to select the radio transmitter among a plurality of radio transmitters. For example, the selection input may be in the form of an address of the premises where the radio transmitter is placed. Alternatively, the selection input may be in the form of the identification of the radio transmitter.

Additionally, in an embodiment, the sales agent may also provide the time indicator at which the radio transmitter is to be in a selected operational state, such as activated or deactivated. Further, in an embodiment, the mobile app executable on the mobile device of the sales agent may be configured to automatically determine the time indicator based on a calendar schedule of the sales agent. For example, the mobile app may be configured to communicate with a calendar application executable on the mobile device of the sales agent. Further, the calendar schedule may include a time at which either the sales agent or a client of the sales agent is scheduled to visit the premises.

Accordingly, the radio transmitter may include a control circuitry configured to transition the radio transmitter between a low power state, such as OFF state, and a high power state, such as an ON state, based on receipt of the control commands such as, the wake-up command and the sleep command. The control circuitry may include, for example, a processor configured to decode electromagnetic signals received from the system in order to identify and extract the control commands.

Additionally, in an embodiment, the radio transmitter may include a real time clock. Accordingly, the control circuitry may be further configured to control an operational state of the radio transmitter based on the time indicator present in the control command.

For example, the system may be configured to receive a calendar schedule of the sales agent indicating a visit by the client at a scheduled time. Further, the system may be configured to transmit the scheduled time to a mobile device that may be in the vicinity of the radio transmitter or is likely to be in the vicinity of the radio transmitter in the near future. Accordingly, the mobile device at the premises may receive the scheduled time and re-transmit the scheduled time to the radio transmitter.

Subsequently, the radio transmitter may receive and store the scheduled time in the memory module. Thereafter, the control circuitry may periodically compare the value of the real time clock with the scheduled time. When the real time clock indicates a time equal to or greater than the scheduled time, the radio transmitter may be automatically turned ON from an otherwise OFF state. As a result, power consumption of the radio transmitter may be reduced, resulting in a longer operation period of the radio transmitter.

Further, the communication module included in the system is configured to receive identification of one or more radio transmitters. For instance, the communication module may be configured to communicate with the mobile device at the premises, such as a mobile phone, over one or more communication channels such as, for example, data channel, Short Messaging Service (SMS) and voice channel in order to receive the identification of one or more radio transmitters.

Accordingly, the mobile device at the premises may be configured to transmit the identification over the one or more communication channels. For example, the mobile device at the premises, such as a smartphone, may include a mobile app configured to periodically scan for presence of electromagnetic signal from the one or more radio transmitters. Further, the mobile app may be configured to decode the electromagnetic signal to obtain the identification of the one or more radio transmitters. The identification of the one or more radio transmitters may include, for example, but is not limited to, unique serial numbers corresponding to the one or more radio transmitters.

Furthermore, the mobile app may be configured to transmit the identification to the system, for example, in the form of a HTTP POST message. Additionally, in some instances, the mobile app may be configured to include a timestamp corresponding to the receipt of the electromagnetic signal from the one or more radio transmitters. Alternatively, the timestamp may correspond to a time of transmission of the identification from the mobile device to the system.

Further, in some instances, the mobile app may be configured to automatically detect and transmit the identification of the one or more radio transmitters. Alternatively, the mobile app may be configured to detect and/or transmit the identification of the one or more radio transmitters based on an input from the user of the mobile device.

Further, the system includes a processing module configured to associate an information with the premises. The information may include, for example, the information related to the premises explained in detail in the preceding paragraphs. Further, the premises may be identifiable by a premises identifier, such as, for example, a name of the premises. Additionally, in some instances, the premises identifier may include an address of the premises. Likewise, the information may be identified by an information identifier, such as for example, a name of the premises. Accordingly, the processor may be configured to associate the information with the premises based on a match between the premises identifier and the information identifier. However, in some other instances, the processor may be configured to associate the information with the premises based on any other common arbitrary identifier.

Furthermore, in some other instances, the processing module may be configured to associate the information with the premises based on an input from a user, such as a sales agent and/or an owner of the premises. For example, the owner of the premises may provide each of the premises identifier and the information to the system while registering the premises with the system. Accordingly, the processing module may associate the information with the premises. Additionally, in some instances, the processing module may be further configured to store the association between the information and the premises in a storage device, such as the storage module included in the system.

Additionally, the processing module is configured to associate the identification of one or more radio transmitters with the premises. In some other embodiments, the association of the one or more radio transmitters with the premises may be a permanent association. For example, the processing module may be configured to generate a unique identification corresponding to a radio transmitter for use in association with the premises. Accordingly, a sales agent may place the radio transmitter within and/or in the vicinity of the premises.

Alternatively, in an embodiment, the association of the one or more radio transmitters with the premises may be a temporary association. For instance, the association of the identification of the one or more radio transmitters with the premises may be based on physical presence of the one or more radio transmitters within and/or in the vicinity of the premises. For instance, a radio transmitter configured to transmit an arbitrary identification may be physically placed within and/or in the vicinity of the premises by a sales agent. Accordingly, during the time period when the radio transmitter is placed within the premises, the arbitrary identification may be associated with the premises by the processing module.

Alternatively, in some instances, the association of the identification of the one or more radio transmitters with the premises may be based on a time duration. For example, a sales agent may provide a request to the system for using a radio transmitter identified by the identification for a period of a week. Further, the request may also include the premises identifier associated with the premises. Accordingly, the processing module may be configured to associate the identification of the radio transmitter with the premises, independent of a physical location of the radio transmitter. As a result, the sales agent may install the radio transmitter at the premises at a convenient time later on.

Further, in an embodiment, the system may be configured to automatically determine association between the identification of the one or more radio transmitters with the premises. For instance, the system may be configured to identify the premises based on a first data associated with a second user, such as a sales agent. In general, the first data may be any information indicative of a physical presence of the sales agent and/or the mobile device of the sales agent within and/or in the vicinity of the premises.

Accordingly, in an embodiment, the first data may include a calendar note associated with the second user, such as, for example, the sales agent. For instance, the calendar note may include a scheduled visit of the sales agent and/or one or more clients to the premises. Accordingly, the system may be configured to receive the calendar note from the mobile device of the sales agent and or a mobile device of a client. As a result, the system may have access to information about a time when the second user may be physically present at the premises.

Further, in some other embodiments, the first data may include a position information of the second user, such as, for example, the sales agent. For instance, the mobile device of the sales agent may be configured to determine a geographical location, by using, for example, a GPS receiver included in the mobile device of the sales agent. Further, a mobile app installed on the mobile device of the sales agent may be configured to communicate the position of the second user to the system. In some instances, the mobile app may be configured to periodically report the position information to the system. As a result, the system may have access to the latest position of the second user. Accordingly, based on a correlation between an address of the premises with the position information, the system may be able to determine the physical presence of the second user within and/or in the vicinity of the premises.

Further, in another embodiment, the system may be configured to receive a first data from the mobile device of the second user, such as, for example, the sales agent. For instance, upon reaching the premises, the sales agent may provide the first data as an input to the mobile app executable on the mobile device of the sales agent. Accordingly, the mobile app may be configured to transmit the first data to the system along with the identification of the one or more radio transmitters. As a result, the system may determine the physical presence of the sales agent at the premises.

Further, in order to associate the one or more radio transmitters with the premises, the sales agent may be assigned a plurality of radio transmitters. For example, initially, the sales agent may be assigned a first set of radio transmitters with a corresponding first set of identification. Accordingly, when the sales agent carrying the first set of radio transmitters is within a premises, the mobile device of the sales agent may receive transmissions from each radio transmitter in the first set of radio transmitters. Accordingly, the mobile device may receive and transmit the first set of identification to the system. As a result, the system may receive the first set of identification at a first time instant.

Further, the sales agent may arbitrarily select one or more radio transmitters from the first set of radio transmitters to be installed within and/or in the vicinity of the premises. Accordingly, with the exclusion of the selected radio transmitter, the sales agent may possess a second set of radio transmitters associated with a second set of identification. However, while the sales agent is still within the proximity of the premises, each radio transmitter may continue to transmit identification to the mobile device of the sales agent. Accordingly, the mobile device may transmit the first set of identification to the system at a second time instant.

However, as the sales agent leaves the premises and visits another location such as, for example, a second premises, the selected radio transmitter may no longer be capable of transmitting its identification to the mobile device of the sales agent due to distance between the premises and the second premises. As a result, the mobile device of the sales agent may only receive the second set of identification transmitted by the second set of radio transmitters. Accordingly, the mobile device may be configured to transmit the second set of identification to the system at a third time instant.

Accordingly, the system may be configured to receive the first set of identification of the first set of radio transmitters at the first time instant and the second set of identification of the second set of radio transmitters at the third time instant. Further, the system may be configured to compare the first set of identification with the second set of identification for finding at least one radio transmitter identification in the first set of identifications, which at least one radio transmitter identification is absent from the second set of identifications. In other words, a result of the comparison may indicate the selected radio transmitter that was left behind in the premises. Accordingly, the system may associate the selected radio transmitter with the premises.

As a result, in an embodiment, the sales agent may not be required to provide any user inputs to associate a radio transmitter with a premises. In other words, the sales agent may arbitrarily select and leave behind one or more radio transmitters from a plurality of radio transmitters at the premises, while the system is configured to automatically associate the selected one or more radio transmitters with the premises.

Accordingly, when a user such, as a client, arrives at the premises, the one or more radio transmitters installed at the premises may transmit the identification to a mobile device of the client. For example, when the client is in the premises, the mobile device may be configured to receive and transmit the identification of the one or more radio transmitters. Accordingly, the system may determine presence of the client at the premises based on the association between the premises and the identification of the one or more radio transmitters.

Accordingly, the processing module is configured to select the associated information to be provided to the user, such as the client, based on the identification received by the communication module. For example, the processing module may perform a database search using the identification as a query in order to retrieve the information related to the premises.

Further, in an embodiment, the information related to the premises may include data for augmenting a view. Accordingly, a user, such as the client, may use a camera of the mobile device in order to capture an image the premises, such as that of the interior of the premises. In an instance, the premises may lack any furnishing. Further, a mobile app installed on the mobile device of the client may be configured to transmit the image to the system.

Further, in an embodiment, the mobile app may also be configured to determine a location of the user in relation to the premises based on electromagnetic signals received from a plurality of radio transmitters installed in the premises. Accordingly, in an embodiment, the plurality of radio transmitters may be further configured to transmit a timestamp corresponding to a time of transmission in addition to the identification of the plurality of radio transmitters. Accordingly, the mobile app may be configured to perform triangulation in order to determine a location of the user in relation to the plurality of radio transmitters.

Further, the locations of the plurality of radio transmitters may be known in relation to a floor plan of the premises. For instance, the sales agent may be required to place the plurality of radio transmitters at a corresponding plurality of predetermined locations within the premises. Alternatively, the sales agent may place the plurality of radio transmitters at different arbitrary locations within the premises. However, in this case, the sales agent may provide an indication of the locations of the plurality of radio transmitters in relation to the floor plan.

For example, the sales agent may choose to place three radio transmitters at three predetermined corners of a room. Accordingly, the mobile app on the mobile device of the sales agent may be configured to present a user interface displaying the floor plan to the sales agent on which, the sales agent may indicate, via touch, the locations where the three radio transmitters were placed. As a result, the mobile app may be configured to determine the position of the user in relation to the floor map of the premises. For instance, the mobile app may be able to determine the room in which the user is currently situated and also the distance of the user from each wall of the room.

Accordingly, the data for augmenting the view may be modified based on the position of the user within the premises. For instance, when the user holds the mobile device towards a wall located in the premises, the mobile app executable on the mobile device of the user may be configured to determine the location of the mobile device as being in the room, as well as the distance of the mobile device from the wall. Accordingly, data for augmenting the view, such as wall paper pattern, may be appropriately scaled based on the distance in order to provide a realistic augmented view to the user.

Additionally, in an embodiment, the system may be configured to monitor visits of one or more users, such as the user, to the premises and accordingly transmit a report of the visits to one or more other users, such as a sales agent. For instance, each of the sales agent and a user, such as a first client, may be located in a premises where a first radio transmitter is installed. Accordingly, each of the mobile device of the sales agent and the mobile device of the first client may receive the identification of the first radio transmitter. Further, a second client may be situated in another premises where a second radio transmitter is installed. Accordingly, a mobile device of the second client may receive identification of the second radio transmitter.

Accordingly, the mobile device of the second client may transmit the identification of the second radio transmitter to the server. Likewise, each of the mobile device of the sales agent and the mobile device of the first client may also transmit the identification of the first radio transmitter. As a result, the system may have access regarding location of one or more clients, such as the first client and the second client at corresponding one or more premises.

Further, in some instances, the mobile app installed on the mobile devices of the clients, may be configured to periodically transmit identification of the one or more radio transmitters. As a result, the system may be able to determine a time period during which a mobile device of a user, such as a client, was present at a premises. Accordingly, the system may transmit information regarding visits of one or more users to one or more premises to the mobile device of the sales agent. Further, the information regarding a visit may include a time of the visit, a duration of the visit and identification of the user who made the visit.

Further, in accordance with an embodiment, the method relates to providing information related to the premises on a mobile device based on proximity of the mobile device to one or more radio transmitters. The information related to the premises may include at least one of a listing description, a floor plan, a plurality of images associated with the real estate property and an image of at least one object.

Accordingly, the method may include a step of receiving identification of the one or more radio transmitters from a first mobile device. Accordingly, the first mobile device may be configured to receive the identification of the one or more radio transmitters transmitted by the one or more radio transmitters placed within the premises.

Additionally, the method may include a step of receiving a first data from the first mobile device. Further, the method may include a step of associating the information related to the premises with the identification of the one or more radio transmitters based on the first data. Furthermore, the method may include a step of receiving a query from a second mobile device. The query may include the identification of the one or more radio transmitters. Accordingly, the second mobile device may be configured to transmit the query based on receipt of the identification of the one or more radio transmitters transmitted by the one or more radio transmitters. Additionally, the method may include a step of identifying the information related to the premises associated with the identification of the one or more radio transmitters in the query. Further, the method may include a step of transmitting the information related to the premises to the second mobile device based on the identifying. Accordingly, the second mobile device may be configured to present the information related to the premises.

Further, in an embodiment, the first data may include a geographical location of the first mobile device. Furthermore, the first mobile device may include a satellite receiver configured to determine the geographical location. Accordingly, the associating may be based on a result of comparing the geographical location of the first mobile device with a geographical location corresponding to the premises.

Further, in an embodiment, the first data may include a premises identifier associated with the premises. Further, the first mobile device may be configured to receive an indication of the premises identifier from a user of the first mobile device.

Further, in an embodiment, the first data may include a calendar note corresponding to the user of the first mobile device. Furthermore, the calendar note may include each of a time indicator and a location indicator. Accordingly, the user of the first mobile device may be scheduled to be physically present at a location represented by the location indicator at a time represented by the time indicator.

Further, receiving the identification of the one or more radio transmitters from the first mobile device may include receiving a first set of identifications from the first mobile device during a first time interval and a second set of identifications from the first mobile during a second time interval. Furthermore, the associating of the identification of the one or more radio transmitters with the information related to the premises may be based further on a comparison of the first set of identifications and the second set of identifications.

Additionally, in an embodiment, the method may further include receiving a location of the second mobile device. Furthermore, the location may be determined based on triangulation of signals received from a plurality of radio transmitters. Additionally, the method may include identifying at least one view of the premises. Further, the at least one view may be associated with the location. Furthermore, the information related to the premises transmitted to the second mobile device may include the at least one view.

Further, in an embodiment, the information related to the premises may include augmentation data. Furthermore, the second mobile device may be configured to present at least one augmented view corresponding to the at least one view based on the augmentation data.

Further, in an embodiment, the method may further include receiving an augmentation selection from the user of the second mobile device. Additionally, the method may include generating the augmentation data based on the augmentation selection. Further, in an embodiment, the augmented view may be presented based on at least one image captured by the second mobile device.

Further, in an embodiment, the at least one radio transmitter may be configured to receive a calendar note from at least one of the first mobile device and the second mobile device. Furthermore, the at least one radio transmitter may be configured to be transitioned to at least one of an active state and an inactive state based on the calendar note. Additionally, the at least one radio transmitter may include each of a storage device configured to store the calendar note, a real time clock and a processor configured to cause the transition based on the calendar note and a value of the real time clock. Further, a power of radio waves transmitted by the at least one radio transmitter operating in the active state may be greater than the power of radio waves transmitted by the at least one radio transmitter operating in the inactive state.

Further, in an embodiment, the calendar note may be associated with a calendar application executable on at least one of the first mobile device and the second mobile device.

Further, in an embodiment, the method may include determining presence of the second mobile device within the premises based on receipt of the query. Furthermore, the method may include transmitting a presence indicator to the first mobile device. Additionally, the presence indicator may be representative of the presence of the second mobile device within the premises.

Further, in an embodiment, the at least one radio transmitter may be placed in at least one predetermined locations within the premises.

Further, in an embodiment, the method may further include receiving at least one placement indicator corresponding to placement of the at least one radio transmitter within the premises. Furthermore, the at least placement indicator may be received from the user of the first mobile device. Additionally, identifying the at least one view of the premises may be based further on the at least one placement indicator.

The methods and systems for providing information related to premises of the present disclosure provide various advantages. For example, users, such as clients, who may be interested in purchasing and/or renting a premises may be conveniently provided with relevant information related to the premises upon arrival at the premises. Accordingly, the users need not perform any explicit request for the relevant information. Further, by automatically determining locations of a user within the premises, the user may be presented with more realistic augmented views of the premises. Further, users such as sales agent may conveniently associate one or more radio transmitters with a premises by arbitrarily selecting the one or more radio transmitters from a plurality of radio transmitters and leaving them behind at a premises, while the system is configured to automatically determine which of the plurality of radio transmitters has been left behind at the premises. Further, users such as the sales agent may remotely control an operational state of the radio transmitters based on for example, a time of visit by a client and/or the sales agent. Accordingly, power consumption of the radio transmitters may be controlled resulting in longer operational period.

### DETAILED DESCRIPTION OF THE DRAWINGS

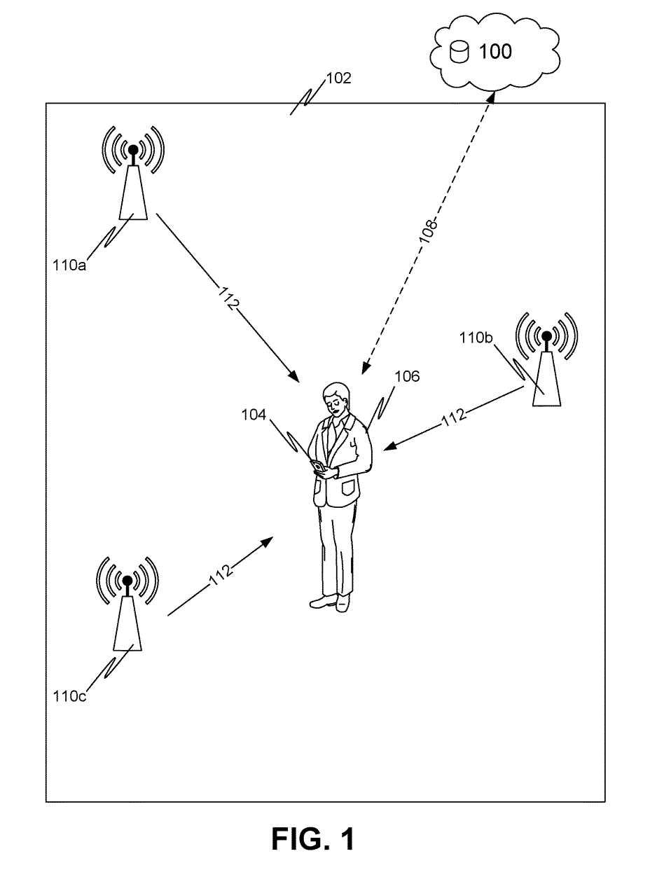

FIG. 1 is a schematic illustration of a plurality of radio transmitters 110, such as 110a-c placed in a premises 102 to facilitate detection of a location of a user 106 within the premises 102 in accordance with an embodiment of the present disclosure. As shown, the user 106 may carry a mobile device 104. The mobile device 104 may include a mobile app configured to receive identification of the plurality of radio transmitters 110 over communication channel 112, such as, Bluetooth. Further, the mobile app may be configured for transmitting the identification of the one or more transmitters 110 to the system 100, such as a server computer. Accordingly, the system 100 may be configured to identify information related to the premises 102 based on the identification. In other words, the system 100 may previously include an association between the identification of the one or more radio transmitters 110 and the information related to the premises 102. Accordingly, the system 100 may retrieve and transmit the information related to the premises 102 to the mobile device 104 of the user 106. Accordingly, the user 106 may be presented with relevant information regarding the premises 102.

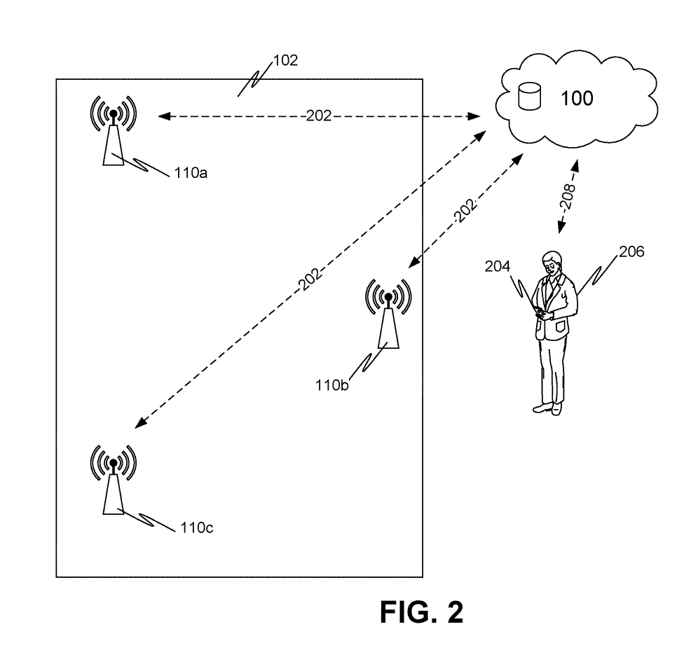

FIG. 2 is a schematic illustration of a system 100 for controlling a plurality of radio transmitters 110, such as 110a-c, placed in a premises in accordance with an embodiment of the present disclosure. The system 100 may be configured to receive one or more control commands from a user, such as the sales agent 206. Accordingly, the system may be configured to communicate with a mobile device 204 operated by the sales agent 206 over a communication channel 208, such as, for example, the Internet. The one or more control commands may include, for example, a wake-up command and a sleep command. Further, the one or more commands may also include a time indicator when a corresponding command such as wake-up and or sleep is to be issued. Accordingly, the system 100 may receive the one or more commands from the mobile device 204 and transmit the one or more commands to the plurality of radio transmitters 110 over the communication channel 202. The communication channel 202 may include each of a short range communication channel and a long range communication channel. The short range communication channel may be formed between the plurality of radio transmitters 110 and a mobile device in the vicinity of the plurality of radio transmitters 110. The long range communication channel may be formed between the mobile device and the system 100. Accordingly, the plurality of radio transmitters may receive the one or more commands and accordingly change an operational state of the plurality of radio transmitters 110.

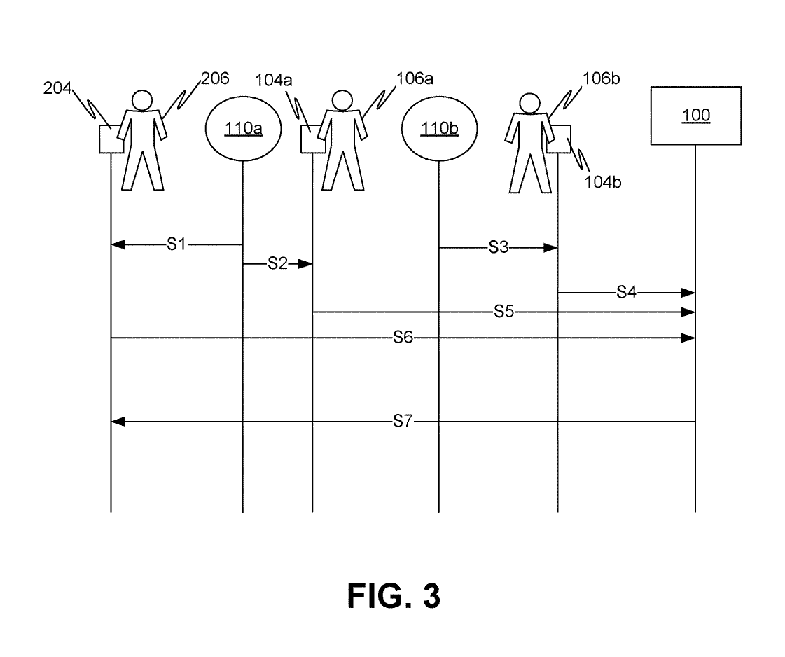

FIG. 3 is a schematic illustration of flow of signals from plurality of radio transmitters 110, such as 110a-b, to a server through one or more mobile devices in accordance with an embodiment of the present disclosure. Each of the sales agent 206 and user 106a, such as a first client, may be located in a premises 102 where a radio transmitter 110a is installed. Accordingly, each of the mobile device 204 of the sales agent 206 and the mobile device 104 of the user 106a may receive the identification of radio transmitter 110a at steps S1 and S2 respectively. Further, a second client 106b may be situated in another premises where a radio transmitter 110b is installed. Accordingly, a mobile device 104b of the second client 106b may receive identification of the radio transmitter 110b at step S3. Subsequently, the mobile device 104b may transmit the identification of the radio transmitter 110b to the server 100 at step S4. Likewise, each of the mobile device 104a and the mobile device 204 may also transmit the identification of the radio transmitter 110a at steps S5 and S6 respectively. As a result, the system 100 may have access regarding location of one or more clients, such as users 106a-b at corresponding one or more premises 102.

Further, in some instances, the mobile app installed on the mobile devices of the clients, such as user 106, may be configured to periodically transmit identification of the plurality of radio transmitters 110. As a result, the system 100 may be able to determine a time period during which a mobile device 104 was present at a premises 102. Accordingly, the system 100 may transmit information regarding visits of one or more users 106a-b to one or more premises to the mobile device 204 of the sales agent 206 at step S7. Further, the information regarding a visit may include a time of the visit and a duration of the visit.

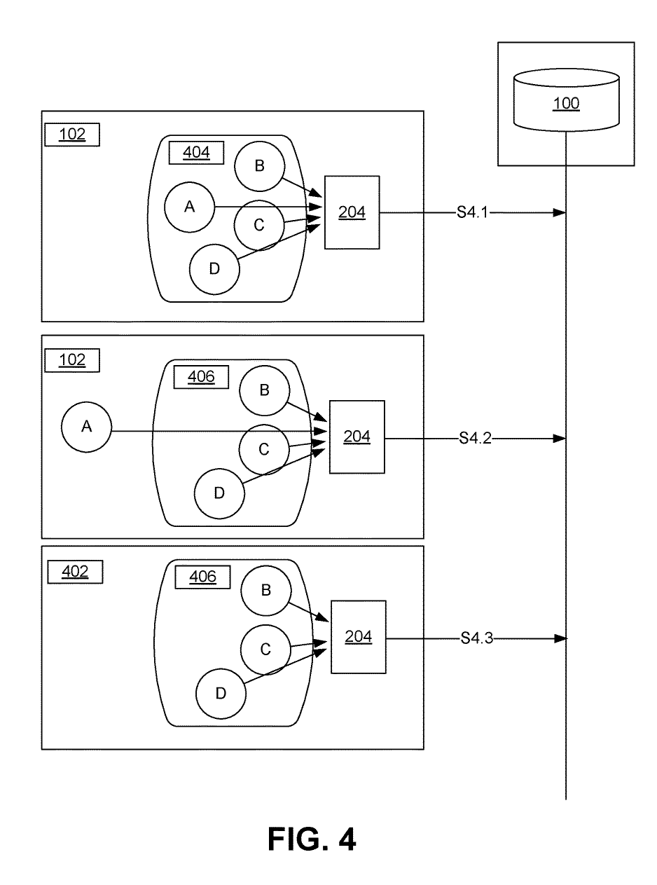

FIG. 4 is a schematic illustration of a technique of associating one or more radio transmitters 110 with a premises 102 based on signals transmitted from the one or more radio transmitters 110 to a server 100 through a mobile device 204 in accordance with an embodiment of the present disclosure. As illustrated, initially, the sales agent 206 may be assigned a first set 404 of radio transmitters 110 with corresponding identification labelled ‘A’, ‘B’, ‘C’ and ‘D’. Accordingly, when the sales agent 206 carrying the first set 404 of radio transmitters 110 is within the premises 102, the mobile device 204 of the sales agent 206 may receive transmissions from each radio transmitter 110 in the first set 404. Accordingly, the mobile device 204 may receive and transmit a first set of identification including ‘A’, ‘B’, ‘C’ and ‘D’ to the system 100 at step S4.1. As a result, the system 100 may receive identification ‘A’, ‘B’, ‘C’ and ‘D’ at a first time instant.

Further, the sales agent 206 may arbitrarily select one or more radio transmitters from the first set 404 to be installed within and/or in the vicinity of the premises. For example, as shown, the sales agent 206 may select the radio transmitter 110 with identification labelled ‘A’ to be left behind at the premises. Accordingly, with the exclusion of the radio transmitter 110 with identification labelled ‘A’, the sales agent 206 may possess a second set 406 of radio transmitters 110 with identification labelled ‘B’, ‘C’ and ‘D’. However, while the sales agent 206 is still within the proximity of the premises, each radio transmitter 110 may continue to transmit identification to the mobile device 204 of the sales agent 206. Accordingly, at step S4.2, the mobile device 204 may transmit first set of identification including ‘A’, ‘B’, ‘C’ and ‘D’ to the system 100 at a second time instant.

However, as the sales agent 206 leaves the premises 102 and visits another location such as, for example, a premises 402, the radio transmitter 110 with label ‘A’ may no longer be capable of transmitting the identification to the mobile device 204 of the sales agent 206 due to distance between the premises 102 and 402. For example, as illustrated, while the sales agent 206 is within the premises 402, the mobile device 204 receives identification ‘B’, ‘C’ and ‘D’. Accordingly, at step S4.3, the mobile device 204 may be configured to transmit a second set of identification including ‘B’, ‘C’ and ‘D’ to the system 100 at a third time instant.

Accordingly, the system 100 may be configured to receive the first set of identifications of the first set 404 of radio transmitters 110 at the first time instant and the second set of identification of the second set 406 of radio transmitters 110 at the third time instant. Further, the system 100 may be configured to compare the first set of identifications with the second set of identifications for finding at least one radio transmitter identification in the first set of identifications, which at least one radio transmitter identification is absent from the second set of identifications. For example, by comparing the first set of identification {A′, ‘B’, ‘C’, D′} received at the first time instant with the second set of identification {′B′, ‘C’, D′} received at the third time instant, the system 100 may determine that the radio transmitter 110 having the label ‘A’ is absent in the second set. Accordingly, the system 100 may infer that the radio transmitter 110 having label ‘A’ was left behind by the sales agent 206 at the premises 102. Accordingly, the system 100 may associate the radio transmitter with label ‘A’ with the premises 102. As a result, in an embodiment, the sales agent 206 may not be required to provide any user inputs to associate a radio transmitter 110 with a premises 102. In other words, the sales agent 206 may arbitrarily select and leave behind one or more radio transmitters 110 from a plurality of radio transmitters 110 at the premises 102, while the system is configured to automatically associate the selected one or more radio transmitters 110 with the premises 102.

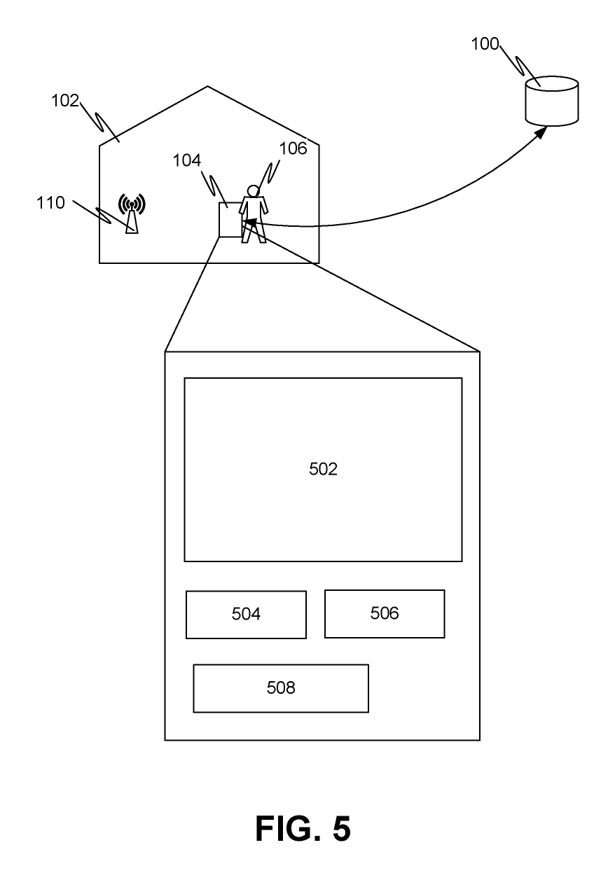

FIG. 5 is a schematic illustration of a user interface, including information regarding a premises 102, presented to a user 106 located in the premises 102 in accordance with an embodiment of the present disclosure. When the user 106 is physically present in the premises 102, the mobile device 104 may receive identification of the radio transmitter 110 installed at the premises 102. Subsequently, the mobile device 104 transmits the identification to the system 100 which then identifies and transmits information related to the premises 102 to the mobile device 104. For example, as shown by an expanded view of the display screen of the mobile device 104, the user interface may display a listing description 502. Further, the user interface may include a GUI element 504 configured to receive a user input and in response, display the floor plan of the premises 102. Additionally, the user interface may include a GUI element 506 configured to receive a user input and subsequently enable the user to place an offer for the premises 102. Furthermore, the user interface may include a GUI element 508 configured to receive a user input and subsequently provide an augmented view of the premises 102 to the user.

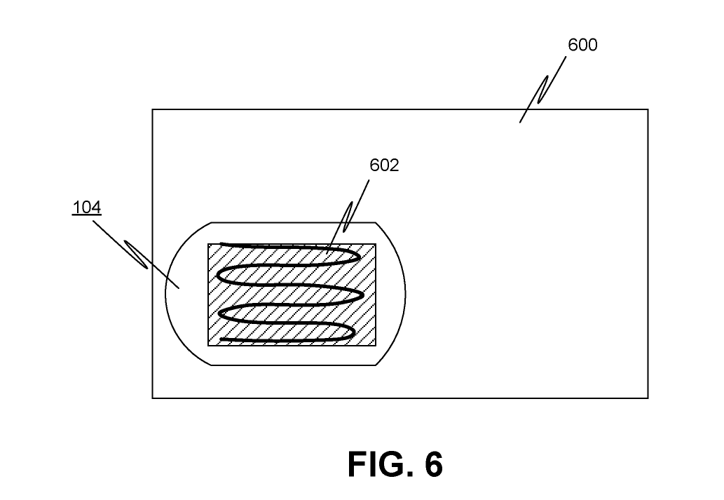

FIG. 6 is a schematic illustration of an augmented view of an interior of a premises 102 presented on a mobile device 104 located within the premises 102 in accordance with an embodiment of the present disclosure. For instance, a user 106 may hold the mobile device 104 with a camera lens of the mobile device 104 being pointed towards a wall 600. Further, the user 106 may provide a selection of a wall-paper to be augmented on the view of the wall. Accordingly, the system may determine the location of the user 106 within the premises and in particular, a distance of the user 106 from the wall 600. Based on the distance, the an image of the wall-paper 602 may be scaled appropriately and displayed on the mobile device 104 in order to provide a realistic augmented view.

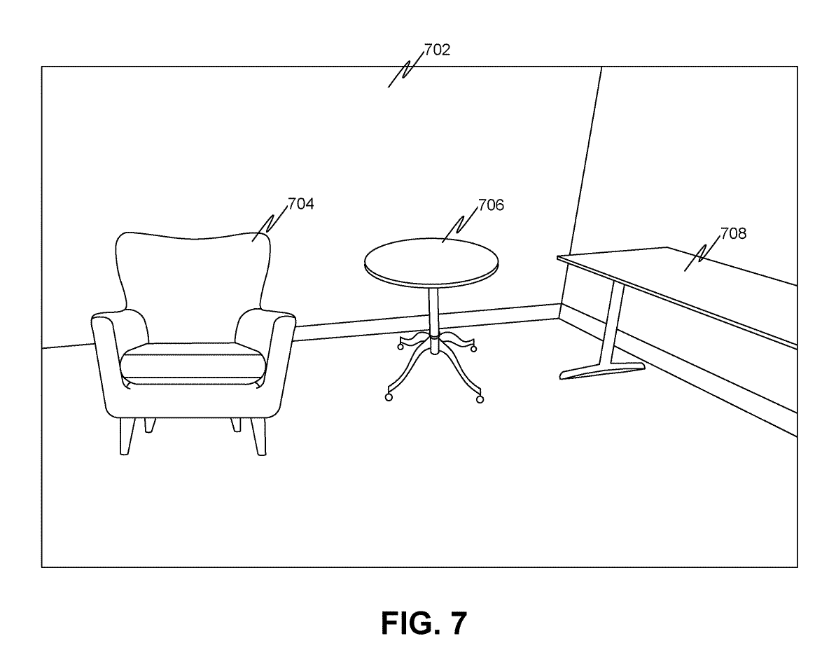

FIG. 7 is a schematic illustration of another augmented view of an interior of a premises 102 presented on a mobile device located within the premises 102. The view illustrates superimposing of images of one or more objects such as, a sofa 704 and tables 706 and 708 onto an image 702 of a room of the premises 102. Further, the images of the one or more objects may be scaled appropriately based on a distance of the user 106 from the walls of the room of the premises 102.

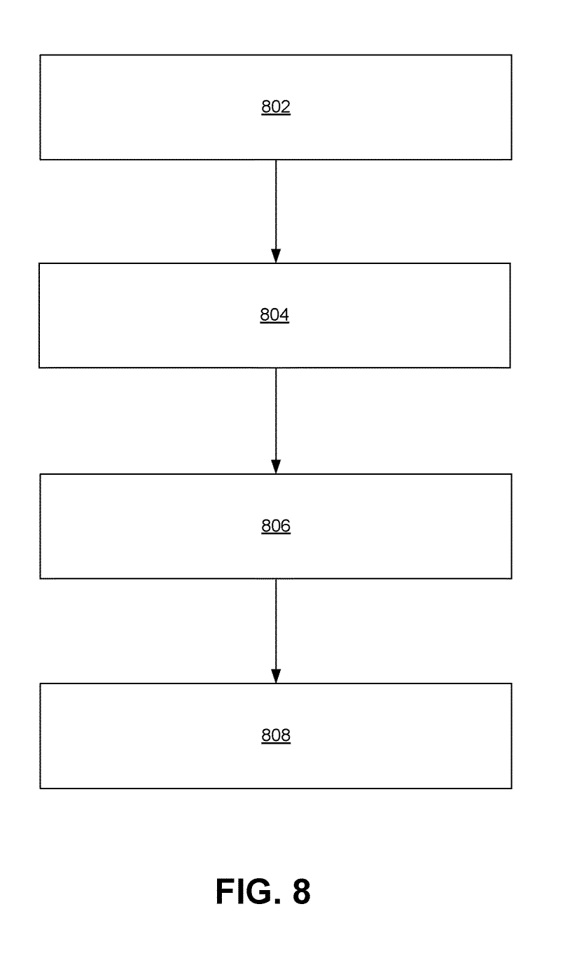

FIG. 8 is an illustration of a flow chart of a method of providing information related to a premises to users. The method may include a step 802 of associating an information with the first premises 102. Further, the method may include a step 804 of associating an identification of one or more radio transmitters 110 with the first premises 102. Furthermore, the method may include a step 806 of receiving the identification of the associated one or more radio transmitters 110. Additionally, the method may include a step 808 of using the received identification to select the associated information to be provided to the first user 106.

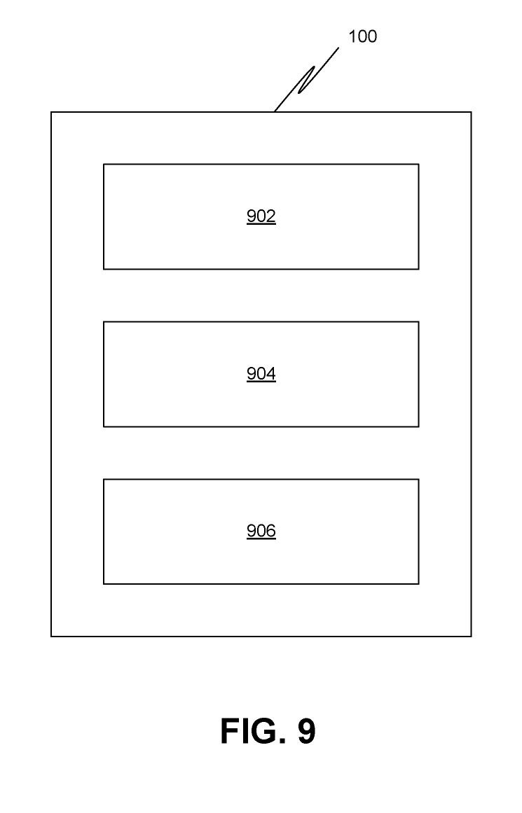

FIG. 9 is a schematic illustration of a system 100 for providing information related to a premises to users. The system 100 may include a communication module 902, a processing module 904 and a storage module 906. The communication module 902 is configured to receive identification of one or more radio transmitters 110. Further, the processing module 904 is configured to associate an information with the first premises 102. Additionally, the processing module 904 is configured to associate the identification of one or more radio transmitters 110 with the first premises 102. Further, the processing module 904 is also configured to select the associated information to be provided to the first user based on the identification received by the communication module 902. Furthermore, the storage module 906 may be configured for storing the association between the identification of the one or more radio transmitters 110 and the information related to the premises 102. In addition, the storage module 906 may also be configured for storing the information related to the premises 102 such as, for example, listing description, floor plans, images of interior views and so on.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for providing information related to a first premises (102) to a first user (106), the method comprising:
associating an information with the first premises (102);
associating an identification of at least one radio transmitter (110) with the first premises (102);
receiving the identification of the associated at least one radio transmitter;
using the received identification to select the associated information to be provided to the first user (106).

2. A method of claim 1, wherein associating the identification of the at least one radio transmitter (110) with the first premises (102) comprises steps of:
identifying the first premises (102) based on a first data associated with a second user (206);
receiving a first set of identifications (404) of a first set of radio transmitters;
receiving a second set of identifications (406) of a second set of radio transmitters;
comparing the first set of identifications (404) with the second set of identifications (406) for finding at least one radio transmitter (110) identification in the first set of identifications (404), which at least one radio transmitter (110) identification is absent from the second set of identifications (406);
associating the at least one radio transmitter (110) with the first premises (102), wherein said at least one radio transmitter (110) is associated with the found at least one radio transmitter (110) identification.

3. A method according to claim 1, further comprising using a plurality of radio transmitters in the first premises (102) to locate the first user (106) within the premises (102).

4. A method according to claim 1, wherein the information associated with the first premises (102) is a website.

5. A method according to claim 1, wherein the information associated with the first premises (102) is a data for augmenting a view.

6. A method according to claim 2, wherein the first data is a calendar note.

7. A method according to claim 2, wherein the first data is a position information of the second user (206).

8. A system (100) for providing information related to a first premises (102) to a first user (106), the system (100) comprising:
a communication module (902) configured to receive identification of at least one radio transmitter; and
a processing module (904) configured to:
associate an information with the first premises (102);
associate an identification of at least one radio transmitter (110) with the first premises (102); and
select the associated information to be provided to the first user (106) based on the identification received by the communication module (902).

9. A system (100) of claim 8, wherein to associate the identification of the at least one radio transmitter (110) with the first premises (102):
the communication module (902) is configured to:
receive a first set of identifications (404) of a first set of radio transmitters; and
receive a second set of identifications (406) of a second set of radio transmitters;
and
the processing module (904) is configured to:
identify the first premises (102) based on a first data associated with a second user (206);
compare the first set of identifications (404) with the second set of identifications (406) for finding at least one radio transmitter (110) identification in the first set of identifications (404), wherein the at least one radio transmitter (110) identification is absent from the second set of identifications (406); and
associate the at least one radio transmitter (110) with the first premises (102), wherein said at least one radio transmitter (110) is associated with the found at least one radio transmitter (110) identification.

10. A system (100) according to claim 8, further comprising a plurality of radio transmitters in the first premises (102) to locate the first user (106) within the premises (102).

11. A system (100) according to claim 8, wherein the information associated with the first premises (102) is a website.

12. A system (100) according to claim 8, wherein the information associated with the first premises (102) is a data for augmenting a view.

13. A system (100) according to claim 9, wherein the first data is a calendar note.

14. A system (100) according to claim 9, wherein the first data is a position information of the second user (206).
